(19) United States
(12) Patent Application Publication
(10) Pub. No.: US 2010/0081115 A1
(43) Pub. Date: Apr. 1, 2010

(54) Computer implemented methods of language learning

(76) Inventors: Steven James Harding, Auckland (NZ); Jon David Wenmoth, Auckland (NZ); Paul Duncan Smith, Titirangi (NZ); John Robert Powell, Auckland (NZ)

Correspondence Address: KENYON & KENYON LLP, ONE BROADWAY, NEW YORK, NY, 10004, US

(21) Appl. No.: 11/632,405

(22) PCT Filed: Jul. 12, 2005
(86) PCT No.: PCT/NZ05/00170

§ 371 Date: May 26, 2009

(30) Foreign Application Priority Data
Jul. 12, 2004 (NZ) 534092

(51) Int. Cl. G09B 19/06; G09B 5/00

(52) U.S. Cl. 434/157; 434/308

(57) ABSTRACT

A computer-implemented method of language learning, which displays a three dimensional environment on a user display. A user can navigate a character representation (3) around the environment. A plurality of destination points (2A, 2B, 2C) are provided in the environment for the character (3), wherein at least at selected destination points either exemplar or interactive conversations (7, 8) are initiated with the character (3).

### TECHNICAL FIELD

The present invention relates to computer implemented methods of language learning and in particular, but not exclusively to methods of language learning utilising computer networks.

### BACKGROUND

Learning a new language is a difficult and lengthy process for most people, particularly where they are not exposed to the language by their friends, family and colleagues. Access to a personal tutor is not always available to everyone for various reasons and therefore software has been developed to enable computer-based learning. However, the Applicant believes that existing software for assisting language learning is not optimum and can be improved upon, or at least do not suit everybody's learning style.

Therefore, there is a need for computer implemented methods of language learning that provide an improved teaching tool, or at least a need for alternative computer-based methods of language learning from those presently available.

### SUMMARY OF THE INVENTION

According to one aspect, the invention resides in a computer-implemented method of language learning, the method including displaying on a user display an environment in which a user can navigate a character representation around the environment, and a plurality of destination points for the character, wherein at least at selected destination points either exemplar or interactive conversations are initiated with the character.

According to another aspect, the invention resides in a computer-implemented method of language learning, the method including:

a) displaying on a user display an environment that has at least one character that when selected conducts a conversation using at least one of the user display and a speaker at the user display;
b) enabling a user to select one of said at least one character,
c) displaying a number of options for phrases to be communicated to the selected character, at least one of which is appropriate and at least one of which is not appropriate or less appropriate and allowing the user to select one of said options; and
d) providing feedback to the user whether or not an option selected by the user was appropriate or the most appropriate.

In one embodiment, step a) may involve displaying at least two of said characters and step b) may involve allowing the user to navigate around the environment to select one of said characters.

According to another aspect, the invention resides in a computer-implemented method of language learning, the method including:

a) displaying on a user display a plurality of characters, at least one of which is a first and at least one of which is a second type;
b) when a character of the first type is selected, displaying a number of options for phrases to be communicated to the selected character, at least one of which is appropriate and at least one of which is not appropriate or less appropriate, allowing the user to select one of said options, and then providing feedback to the user whether or not an option selected by the user was appropriate or the most appropriate; and
c) when a character of the second type is selected, displaying text of and/or playing speech of an exemplar conversation.

In one embodiment, a speech version of the text selected in step b) is played after selection thereof.

According to another aspect, the invention resides in a computer-implemented method of language learning, the method including displaying on a user display an environment in which a user can navigate a character representation around and a plurality of destination points for the character, wherein at least at selected destination points either exemplar or interactive conversations are initiated. In one embodiment, the environment includes at least one destination point where interactive conversations are initiated.

According to another aspect, the invention resides in a computer-implemented method of language learning, the method including displaying on a user display an environment in which a user can navigate a character representation around and at least three destination points for the character, wherein first, second and third destination points respectively cause:
a) an exemplar conversation to be displayed on the user display and/or played using a speaker at the user display;
b) an interactive conversation to be initiated, whereby the user controls responses to phrases displayed on the user display and/or played using a speaker at the user display by selecting one of a plurality of options; and
c) an interactive conversation to be initiated, whereby the user controls one side of the conversation by entering phrases using a user input device and a response is extracted from a database and displayed on the user display and/or played using a speaker at the user display.

In one embodiment, the computer-implemented method of language learning includes providing an environment in which a plurality of different users may have conversations with each other over a computer network, with each user adopting a character in the environment that they can navigate around the environment so as to control the character with which they are to converse.

According to another aspect the invention resides in apparatus for learning a language, the apparatus including a computer adapted to provide an output to a user-display to display an environment in which a user can navigate a character representation around the environment, and a plurality of destination points for the character, wherein at least at selected destination points either exemplar or interactive conversations are initiated with the character.

According to another aspect the invention resides in apparatus for learning a language, the apparatus including a server adapted to communicate with a client to display an environment in which a user can navigate a character representation around the environment, and a plurality of destination points for the character, wherein at least at selected destination points either exemplar or interactive conversations are initiated with the character.

In a further aspect the invention resides in a computer programmed in accordance with any one of the preceding aspects.

Further aspects of the present invention will become apparent from the following description, given by way of example only and with reference to the accompanying drawings.

### BRIEF DESCRIPTION OF THE DRAWINGS

FIG. 1: shows a screenshot of a learning environment according to one aspect of the present invention.

FIG. 2: shows an example of an exemplar conversation in the learning environment shown in FIG. 1.

FIG. 3: shows an example interactive conversation in the learning environment shown in FIG. 1.

FIG. 4: shows a flow diagram of a typical learning process using the computer-based learning method of the present invention.

FIG. 5: shows an isometric perspective interactive map of a plurality of learning units.

FIG. 6: shows a diagrammatic architecture of an implementation of the invention.

FIG. 7: shows a screenshot of characters conversing in a collaborative environment outside an environment of a learning unit.

### DETAILED DESCRIPTION OF THE DRAWINGS

The present invention relates to computer-based language learning methods. The invention may be implemented in a computer network environment. The invention uses the concepts of immersive learning, collaborative learning, and educational gaming to bring a learning experience to a user in the form of a user controlled character in a simulated, foreign country environment.

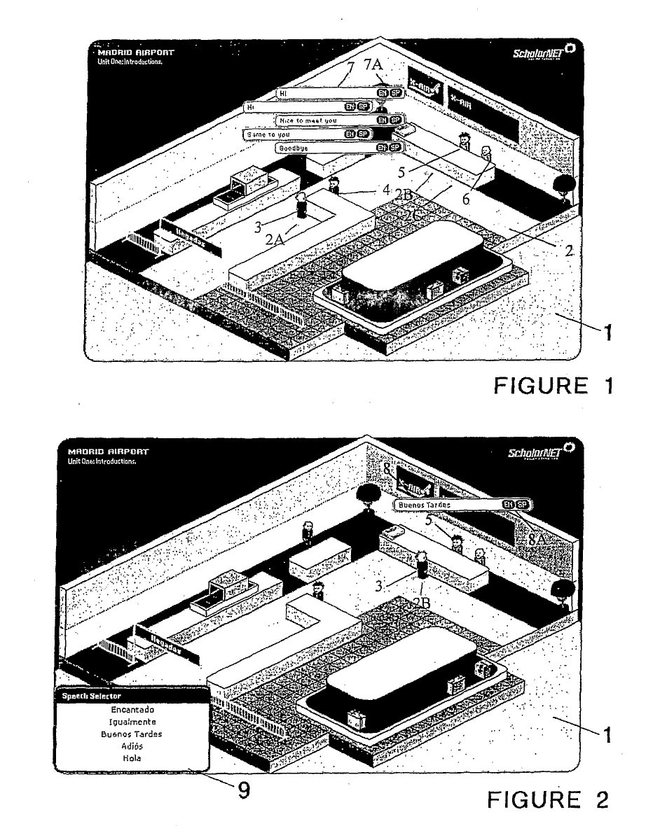

FIG. 1 shows an example of a screenshot that may be displayed on a user display according to the present invention. In the example, an English-speaking user is learning Spanish. The user display (not shown) may be a display associated with a personal computer, personal digital assistant or other computer apparatus suitable for executing software to implement the present invention or receiving information for display from a remote computer processor.

The screenshot depicts an environment 1 in which a person may find themselves in. As shown in FIGS. 1-3, the environment has a three dimensional appearance which is representative of a real world environment. The example in FIG. 1 shows an airport, but it will be appreciated that many alternatives exist. The environment 1 is divided into a number of sections, in this instance into a grid 2 defining a number of spaces.

In FIG. 1, four characters 3-6 are shown. The user adopts one of the characters 3 and may navigate that character to any one of the spaces indicated by the grid 2 that is not occupied by an object or another character. Therefore, the user effectively assumes a role—by way of the character, or avatar, in the environment. If the user navigates their character 3 to one of the spaces 2A 2C, a conversation is initiated with one of the characters 4-6 respectively. The user may navigate the character to a particular grid using a point-and-click device, although those skilled in the relevant arts will appreciate that a number of alternatives exist, including using keyboard commands and/or touch-screens. Also, instead of providing flexibility for the character to move to any space in the grid, the user may be restricted to moving their character to spaces that initiate a conversation or provide information.

The type of conversation initiated when the user navigates their character to one of the spaces 2A-2C varies according to the type of character with which they are to interact. In a preferred embodiment as presently contemplated, there are at least two types of character, an instructional character and a conversational character. However, the instructional character(s) may optionally be omitted and/or a random chat character optionally also provided. For the purposes of example, in FIG. 1 three character types are shown, with character 4 being an instructional character, character 5 a conversational character and character 6 a random chat character.

The character 4, being an instructional character, takes the user through one or more exemplar conversations. Accordingly, the purpose of instructional characters is to demonstrate conversations to the user. The character 4 may have a large number of exemplar conversations available for demonstration and may either automatically cycle through these, or the user may be prompted to indicate that the instructional character should move on to another exemplar conversation, the subject of which may also be selectable by the user. In the preferred embodiment as presently contemplated, the user may terminate the exemplar conversations by moving their character 3 away from space 2A. If the user later returns to space 2A, then the exemplar conversation may resume from the last conversation point. The user may be prompted to indicate whether to resume the conversation from the last point or start again.

As shown in FIG. 1, text of the conversation may be displayed on the user display. This allows the user to see the written form of the words. In FIG. 1, the words are displayed inside speech boxes 7. In addition, a speaker and associated hardware and software (not shown) are used to play a recording of the exemplar conversations. Therefore, the user may obtain the benefit of hearing the spoken form of the words of the exemplar conversations and the benefit of seeing the written form of the words, with the speech boxes 7 preferably appearing at the same time or just before the words are spoken. Although in the preferred embodiment of the invention the written and spoken form of the words is provided to the user through the user display and speaker respectively, one or the other may be provided alone.

The speech boxes 7 may each include language selection icons 7A. In the example shown in FIG. 1, the user can switch between EN (English) and SP (Spanish). Currently, EN has been selected and an exemplar conversation is English has been displayed on the screen. If the user selects SP, the words in the speech boxes 7 are displayed in Spanish. The spoken conversation would have been generated using the speaker in Spanish, as that is the language that the user is learning. The words spoken by the character 4 are in speech boxes 7 that are shifted to the right relative to the speech boxes 7 containing words spoken by the character 3, providing a simple, but effective way of distinguishing between the words spoken by each character.

In FIG. 2, the user has moved the character 3 to space 2B, opposite character 5. Character 5 is a conversational character and therefore initiates a conversation by saying, in this example, “Buenos Tardes” (Good Afternoon). The words may be displayed on screen in a speech box 8 and/or generated using a speaker, preferably both. The speech box 8, like speech box 7, may include, language selection icons 8A.

At the same time as the character 3 initiates a conversation, or immediately afterwards, a speech selector box 9 is displayed with a plurality of options for reply, in this example five options. The user can then select one of the options to say in response. Alternative conversational characters may require the user to initiate the conversation by selecting a number of options.

In another embodiment the user may use an input device such as a keyboard to provide a response by typing a number of words for example, rather than using the speech selector box 9. Also, voice recognition may be used, allowing the user to provide an aural response.

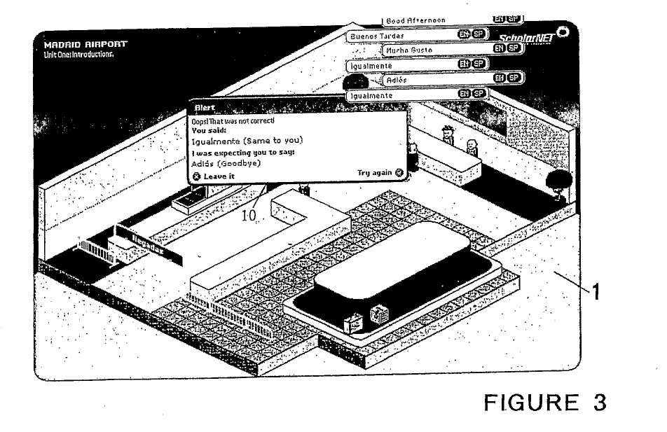

If the user selects or otherwise provides the most appropriate response, then a voice version of that response is played back using the speaker and/or the response is displayed in a further speech box 8, preferably both. The conversational character 5 then makes another comment and another speech selector box 9 may be displayed to the user. If an inappropriate response is selected or otherwise provided, an alert box 10 is displayed on screen. FIG. 3 shows an example where the user selected appropriate responses to the first two parts of the conversation, and then selected an inappropriate (or less appropriate) response “igualmente” to the comment “Adiós”. The alert box 10 explains what the user selected and what the most appropriate response was. The alert box 10 also, in this example, gives the option to the user to select whether to try the conversation again or to move on.

Any other conversational characters provided in the environment will provide a different conversation to the character 5. The character 5 may also cycle through a number of different conversations, selecting a different conversation each time the user moves the character 3 to the space 2B. The selection may be random in order, or in a predefined order.

The character 6 is a random chat character. Characters of this type may provide a next higher step in interaction and learning to the user. When the user navigates their character 3 to space 2C, they are prompted to enter a phrase. Typically, the phrase will be entered using a keyboard by typing in one or more words, although alternatives exist, that may be used instead of, or in addition to this, including allowing the user to navigate through a menu structure of possible words and phrases. Also, an aural response may be provided, the response being detected by the machine using voice recognition.

After a phrase has been entered, a relational database or similar is used to find an appropriate response to that phrase. If the entered phrase is in the database and has a response associated with it, the response is displayed on the user display and/or generated using a speaker, preferably both, in a similar manner to the conversation performed by the conversational character 5, with the difference that the user is controlling the conversation. If the entered phrase is not in the database, the user may be provided with a query of the closest matching options, asking whether they meant to enter one of those or may be given a standard error response. The standard error response may state that they can not respond and optionally provide the reason why (e.g. either the phrase is unknown or does not have a response associated with it).

In a preferred embodiment, the types of characters are visually discernible in the environment 1. In a preferred embodiment the character adopted by the user is a self-built avatar i.e. an image that has visual aspects desired by the user, for example, a likeness of the user or fictional character that the user identifies with.

In addition to characters, the environment 1 may include objects. When a user selects an object, by moving their character 3 to the object or by another method if the specific implementation of the present invention provides for this, information is provided to the user. The objects may be used to explain, for example, aspects of culture, tradition and the like that relate to the object, the situation and/or the environment depicted.

The environments may be classified according to the conversations that the characters in that environment conduct. The example provided herein teaches users how to meet people. Clearly, much more advanced conversations can also be accommodated. Typically, a user will start at the simple level environments and work their way up to more complex environments and optionally a user may be prevented from entering more complex environments until after they have entered all, or a selection of, the less complex environments. Whether or not the user can enter more complex environments if they have not successfully completed conversations with conversational characters in a lower level environment is a decision for each specific implementation. In a preferred embodiment the environment represents a real-world location, such as an airport or café and the situations the user encounters are representative of real-world situations and problems. The applicant believes that this results in an accelerated comprehension of the language being studied.

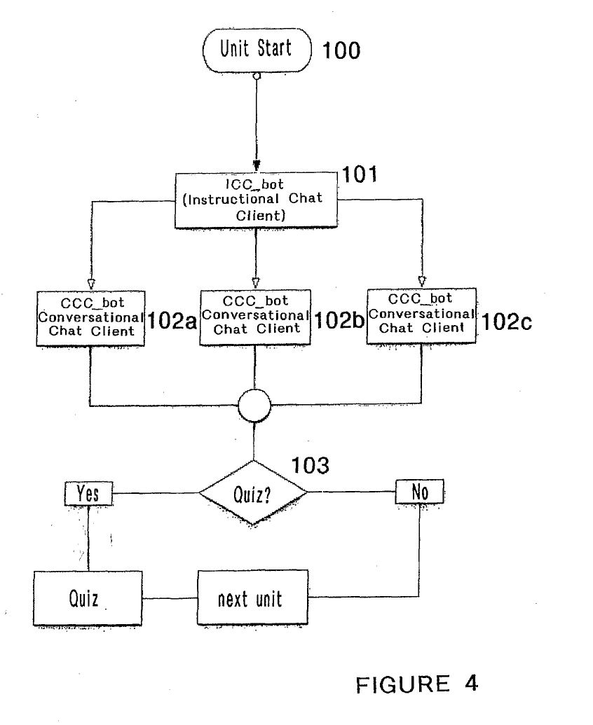

FIG. 4 shows a flow diagram of a possible learning process using the system of the present invention. At step 100, a unit is started by displaying an environment to the user, such as the environment 1. Typically, the user will first move to an instructional character for a demonstration (step 101). The user may optionally be prevented from moving to a conversational character until they have moved to one or more instructional characters. The user may then move on to a conversational character (steps 102a-102c). In FIG. 4, options for three different conversational characters are illustrated although, more or less than three conversational characters may be available in the environment.

If the user successfully completes a conversation with a character, they move on to step 103 and are asked if they wish to be quizzed. If they select yes, then they are tested on their knowledge, typically using a question and answer approach. If they select no, they move on to the next unit of learning, which may be different conversations in the same environment or a different environment. In one embodiment each unit is bound by preceding or posthumous cut-scenes (for example a scene showing a more detailed view of the user's character in conversation with another character in the relevant environment) that act as a vehicle for extra information to bring continuity and reality to the user experience.

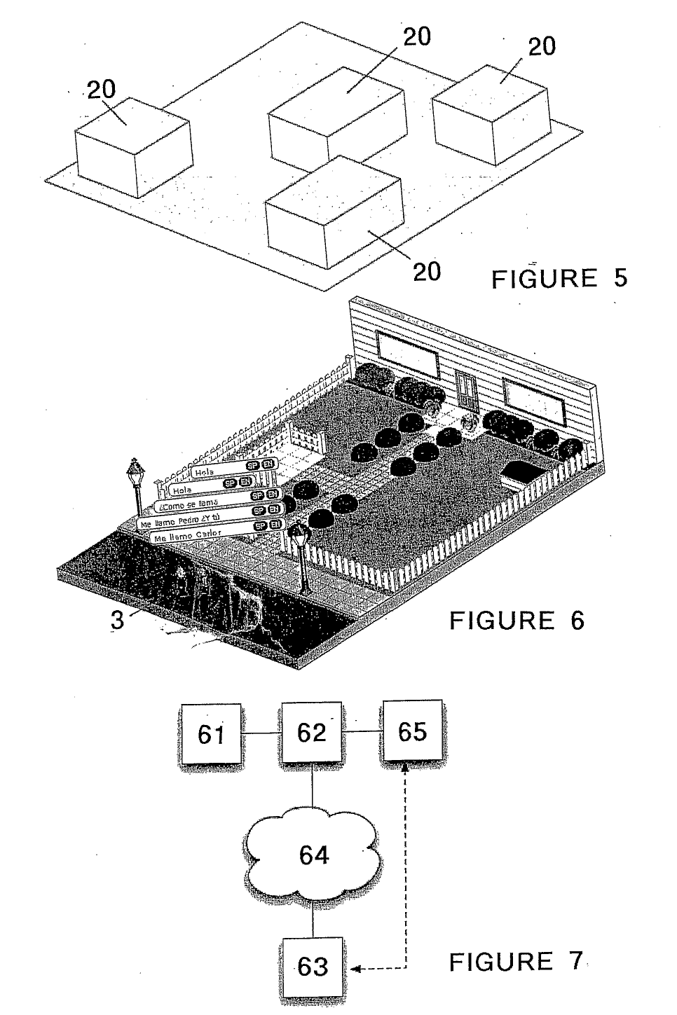

In order to move on to the quiz or next unit, the user may have to complete a minimum set of conversations with one or more conversational characters. Accordingly, steps 102a-102c may each involve a number of conversations or the steps may be placed in series instead of parallel. The user may have an electronic account that is incremented when they successfully complete conversations and/or successfully complete a quiz. An amount in the electronic account could be traded for a reward. This may encourage learning, particularly in environments like schools. In one embodiment, the electronic account may allow users to access specific software, for example provide credits for a game. Users are able to opt between navigating non-linearly to units of choice, or to navigate in a sequential fashion restricted by their progress. The principal method of navigation is by way of isometric perspective interactive map such as that shown in FIG. 5 where different units are referenced 20.

Therefore, the user exists in a virtual world in a three dimensional environment, but is constrained by the limitations of natural life. Learning milestones and compliancy benchmarks may be measured through in-unit, situation-based, self review modules. Interaction can thus be oriented to guide the user toward an understanding of the learning outcomes for that unit.

The invention may be implemented using networked client-server technology. An example of a diagrammatic architecture of one implementation is illustrated in FIG. 6 which shows an XML database 61 in communication with host 62. The client 63 communicates with the host via a network 64. Each client uses a mixture of server-side and client-side application logic to represent units of learning by way of computer graphics, audio files and communication information. Further extensibility can be added by plug-in to allow real time collaboration (which is discussed further below) and voice recognition using an XML Socket server and component interaction using appropriate technology such as that known under the trade mark ActiveX.

The client 63 will typically be a personal computer and the network 64 will typically be a LAN or WAN. The client software establishes a connection to host server 62 which may be either a local server (LAN) or provider server (WAN). The client may at times connect to their respective server via XML RPC, HTTP, AMF via PHP or XML via persistent socket, depending on the current function of the client.

In another example, the invention may function using a web-based client. A Flash communication server 65 may be provided to allow the use of Flash technologies. Furthermore, AMFPHP remoting, PHP, XML, and MySQL technologies may be used.

At instantiation the client makes a remote procedure call to retrieve appropriate data, in this instance XML files which contain the information necessary to build the environment. Assets are dynamically loaded or generated at runtime into a sequence container for temporal deployment. The client builds a navigation map at this point based on the XML data structure defined. The client retrieves user parameters derived from the application host and creates a user profile including historical tracking. If real-time collaboration is required (see below for further information), the infrastructure is instantiated at this point. The virtual unit is constructed; the characters (avatars) are instantiated. Each non-user character (robot avatar) is an interaction point for the user, and stores its own unique behavioural pattern, learning outcomes and response information, or link to response information source. The sequence of events are constructed then implemented over timed or triggered events.

From a user perspective, the user accesses an appropriate client machine, logs in to the provider, and navigates to the appropriate subject.

The system remembers the user's profile, and the user is shown his or her character and synopsis of activity and performance. The user is given the choice to change the user's profile, modify options or begin/resume.

The user may then be presented with the navigational map, indicating progress to date. Using the map a unit may then be selected and loaded. The instructional character may give the user an overview in text and audio of the language constructs required to interact appropriately in this situation. The instructional character may then proceed to guide the user through the environment. Using a combination of written or spoken phrases and selected choices from the phrase selection box, the user makes it through the interaction. This is repeated for key elements in the unit. Upon completion the instructor asks whether the user would like to be questioned about the new phrases that the user has learnt. If the user responds ‘Yes’, then the instructor asks a series of curriculum-defined questions that are marked and stored in the user's progress history. The user is now presented with a choice; leave unit, roam freely (collaborative mode) or explore the unit without the instructor. The latter option lets the user “walk” freely around the environment, trying the interactions again without the instructor's assistance.

The system is extensible to include real time client collaboration over persistent XML socket. The extension enlarges or extends the environment to include non unit-based activity in which clients may roam freely, interacting with other clients. This is achieved with the addition of virtual ‘Streets’, as can be seen in FIG. 7, that allow the user to segue between unit and collaborative environment in context. For example, if the user is represented in a cafeteria unit, the user is then able to walk “outside” into the street where the unit does not exist and freely interact with other users in real time. This extends the navigation structure to allow virtual “roaming” between units, by way of the user character “walking”. In roaming mode, the instructional character may follow the user and act as a prompt toward areas of interest.

Those skilled in the relevant arts will appreciate that the environment 1 could be accessed by a user through a local or wide area computer network, in which case the learning software may be stored on a server connected to the network. This enables remote and self-paced learning. In one embodiment of the present invention, an environment may be displayed in which multiple user characters are displayed, each controlled by a respective user. Different users can then move their characters and initiate conversations with each other. Some automated characters, such as characters 4-6 may optionally also be provided in the environment and could be used for learning purposes while a user awaits another user character to enter the environment.

Those skilled in the relevant arts will appreciate that there a large number of options for the display of information, characters, objects and environments to the user. For example, the characters, objects and/or environments could be more abstract, allowing simpler displays that speed response times. The text may be displayed anywhere on the display in any suitable form and other characters that interact with the user in certain ways may be defined. Also, the user character may be omitted from the display altogether, whereby a user initiates a conversation with other characters not by moving a representation of their character, but by selecting the character with which they wish to interact.

Where in the foregoing description reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

1. A computer-implemented method of language learning, the method including displaying on a user display an environment representative of a real world environment in which a user can navigate a character representation around the environment, and a plurality of destination points for the character, wherein at least at selected destination points either exemplar or interactive conversations are initiated with the character and wherein the user can select a conversation or part of a conversation to be communicated in a language being learnt by the user or in a language already known by the user.

2. A method as claimed in claim 1 wherein a further character representation or object is provided at each destination point and the conversation occurs with the further character or object.

3. A method as claimed in claim 1 wherein the user may modify the appearance of the character representation.

4. A method as claimed in claim 1 wherein the conversation is conducted using at least one of the user display, a speaker at the user display, a microphone at the user display.

5. A method as claimed in claim 1 wherein an interactive conversation includes providing a plurality of options for phrases to be communicated to the character, at least one of which is appropriate and at least one of which is not appropriate or less appropriate, and allowing the user to select one of the options.

6. A method as claimed in claim 5 including providing feedback to the user on whether or not an option selected by the user was appropriate or the most appropriate.

7. A method as claimed in claim 1 including providing at least three destination points for the character, wherein first, second and third destination points respectively cause:
a) an exemplar conversation to be displayed on the user display and/or played using a speaker at the user display;
b) an interactive conversation to be initiated, whereby the user controls responses to phrases displayed on the user display and/or played using a speaker at the user display by selecting one of a plurality of options; and
c) an interactive conversation to be initiated, whereby the user controls one side of the conversation by entering phrases using a user input device and a response is extracted from a database and displayed on the user display and/or played using a speaker at the user display.

8. A method as claimed in claim 1
wherein the environment includes an instructional character which conducts exemplary conversations with the further characters or objects, or provides instruction to the user.

9. A computer programmed to perform a method according to claim 1.

10. Apparatus for learning a language, the apparatus including a computer adapted to provide an output to a user display to display an environment representative of a real world environment in which a user can navigate a character representation around the environment, and a plurality of destination points for the character, wherein at least at selected selected destination points either exemplar or interactive conversations are initiated with the character and wherein the user can select a conversation or part of a conversation to be communicated in a language being learnt by the user or in a language already known by the user.

11. Apparatus for learning a language, the apparatus including a server adapted to communicate with a client to display an environment representative of a real world environment in which a user can navigate a character representation around the environment, and a plurality of destination points for the character, wherein at least at selected destination points either exemplar or interactive conversations are initiated with the character and wherein the user can select a conversation or part of a conversation to be communicated in a language being learnt by the user or in a language already known by the user.

12-13. (canceled)
